(19) United States
(12) Patent Application Publication
(10) Pub. No.: US 2015/0367853 A1
(43) Pub. Date: Dec. 24, 2015

(54) VEHICLE CONTROL DEVICE

(71) Applicant: Hideaki YAGUCHI,, (US)

(72) Inventor: Hideaki YAGUCHI, Toyota-shi (JP)

(73) Assignee: TOYOTA JIDOSHA KABUSHIKI KAISHA, Toyota-shi, Aichi-ken (JP)

(21) Appl. No.: 14/764,771

(22) PCT Filed: Feb. 5, 2013
(86) PCT No.: PCT/JP2013/052593

§ 371 Date: Jul. 30, 2015

(51) Int. Cl. B60W 30/188; B60W 10/04

(52) U.S. Cl. CPC B60W 30/188; B60W 10/04; B60W 2510/18

(57) ABSTRACT

An electronic control unit executes a driving force limiting process, in which, if an accelerator pedal and a brake pedal are simultaneously operated, driving power is set to be smaller than that when only the accelerator pedal is operated. The electronic control unit executes a varying process, in which the lower the vehicle speed is at the time of simultaneous operation of the accelerator pedal and the brake pedal, the shorter the period from simultaneous operation of the accelerator pedal and the brake pedal to the start of the driving power limiting process is set to be.

### TECHNICAL FIELD

The present invention relates to a device that controls driving power of a vehicle.

### BACKGROUND ART

For example, Patent Document 1 discloses a control device that executes a driving power limiting process as one process for controlling the driving power. In the driving power limiting process, the control device reduces the driving power output by a drive source when an accelerator operating member and a brake operating member are being operated together in comparison to when only the accelerator operating member is operated.

### PRIOR ART DOCUMENTS

### Patent Documents

Patent Document 1: Japanese Laid-Open Patent Publication No. 2010-38051

### SUMMARY OF THE INVENTION

### Problems that the Invention is to Solve

The execution of the driving power limiting process immediately after simultaneous operation of the accelerator operating member and the brake operating member is performed may adversely affect drivability.

For example, if simultaneous operation of the accelerator operating member and the brake operating member is accidental and not intended by the vehicle driver, immediate execution of the driving power limiting process will result in deceleration of the vehicle despite the absence of the driver's intention for deceleration, causing drivability to deteriorate. In this regard, a delay process is executed, in which the driving power limiting process is executed after a predetermined delay time has elapsed from when the simultaneous operation of the accelerator operating member and the brake operating member is performed. If such a simultaneous operation is cancelled during execution of the delay process, execution of the driving power limiting process is prohibited. This limits an unintentional drop of the driving power when the simultaneous operation of the accelerator operating member and the brake operating member is accidental. As a result, drivability is restrained from deteriorating.

Also, if the drive force suppression process is executed immediately after simultaneous operation of the accelerator operating member and the brake operating member to significantly lower the drive force, the vehicle deceleration is rapidly increased. This also adversely influences the drivability. In this regard, if a gradual change process for gradually reducing the driving power is executed in a period from simultaneous operation of the accelerator operating member and the brake operating member to the start of the driving power limiting process, the driving power is prevented from being rapidly dropped. Therefore, drivability is not adversely affected by a rapid increase in the vehicle deceleration.

The execution of the above described delay process and the gradual change process means that the driving power limiting process is executed after a certain length of time has elapsed after simultaneous operation of the accelerator operating member and the brake operating member. This limits deterioration of drivability at the execution of the driving power limiting process. However, if the delay process and the gradual change process are executed prior to the execution of the driving power limiting process, the time at which the driving power limiting process is executed is delayed compared to a case in which the driving power limiting process is executed immediately after simultaneous operation of the accelerator operating member and the brake operating member is performed. This extends the time required for the driving power to be sufficiently reduced at simultaneous operation of the accelerator operating member and the brake operating member. Thus, when the accelerator operating member and the brake operating member are simultaneously operated, the braking distance of the vehicle tends to be longer than when normal brake operation is performed, that is, when only the brake operating member is operated. Therefore, to stop the vehicle at a position predicted by the driver when the accelerator operating member and the brake operating member are simultaneously operated, the driver must increase the amount of operation of the brake operating member compared to the normal brake operation. This complicates the brake operation by the driver.

Accordingly, it is an objective of the present invention to simplify brake operation by the driver at the execution of the driving power limiting process when the accelerator and the brake are simultaneously operated.

### Means for Solving the Problems

To achieve the foregoing objective and in accordance with one aspect of the present invention, a vehicle control device including a controller is provided. The controller executes a driving power limiting process, in which the controller reduces a driving power output by a drive source when an accelerator operating member and a brake operating member are being operated together in comparison to when only the accelerator operating member is operated. The controller is configured to execute a varying process in which the lower a vehicle speed is at a time when the accelerator operating member and the brake operating member are simultaneously operated, the shorter a period from when the accelerator operating member and the brake operating member are simultaneously operated to when the driving power limiting process is started becomes.

When the normal brake operation, in which only the brake operating member is operated, is performed, the lower the vehicle speed is, the shorter the braking distance becomes, in general. Hence, the lower the vehicle speed is, the smaller the brake operation amount by the driver becomes. Therefore, even when the driving power limiting process is executed, a lower vehicle speed possibly results in a smaller brake operation amount by the driver. To maintain drivability, the driving power limiting process is executed after a certain period of time has elapsed from when simultaneous operation of the accelerator operating member and the brake operating member is performed. In this case, the braking distance of the vehicle tends to be longer than that in the normal brake operation, in which only the brake operating member is operated. Particularly, in low vehicle speed regions, in which the brake operation amount is small, the braking distance tends to be longer. Thus, the lower the vehicle speed is at the time when simultaneous operation of the accelerator operating member and the brake operating member is performed, the more frequently the brake operation amount is increased and the greater the increase amount of the brake operation amount becomes to stop the vehicle at a position predicted by the driver.

In this respect, the above described configuration executes the varying process so that the lower the vehicle speed is at the time when simultaneous operation of the accelerator operating member and the brake operating member is performed, the earlier the time at which the driving power limiting process is started becomes. Also, the lower the vehicle speed is, the shorter the time required for the driving power to be sufficiently reduced at simultaneous operation of the accelerator operating member and the brake operating member becomes. Thus, when the accelerator operating member and the brake operating member are simultaneously operated, the lower the vehicle speed is, the earlier the time at which the deceleration of the vehicle is increased becomes. Thus, in low vehicle speed regions, it is possible to stop the vehicle at a position predicted by the driver, while limiting the increase in the brake operation amount by the driver. Therefore, this configuration simplifies brake operation by the driver at the execution of the driving power limiting process when the accelerator operating member and the brake operating member are simultaneously operated.

In the above described vehicle control device, the controller is preferably configured to start the driving power limiting process after a predetermined delay time has elapsed from when simultaneous operation of the accelerator operating member and the brake operating member is performed. Also, the controller is preferably configured to execute, as the varying process, a process in which the lower the vehicle speed at the time when the accelerator operating member and the brake operating member are simultaneously operated is, the shorter the delay time is set to be.

In this configuration, the driving power limiting process is started after a predetermined delay time has elapsed from when simultaneous operation of the accelerator operating member and the brake operating member is performed. The lower the vehicle speed is at the time when simultaneous operation of the accelerator operating member and the brake operating member is performed, the shorter the delay time is set to be. Therefore, the lower the vehicle speed is at the time when the accelerator operating member and the brake operating member are simultaneously operated, the shorter can be made the period from when the accelerator operating member and the brake operating member are simultaneously operated to when the driving power limiting process is started.

In the above described vehicle control device, the controller is preferably configured to execute a gradual change process for gradually reducing the driving power in a period from when the accelerator operating member and the brake operating member are simultaneously operated to when the driving power limiting process is started. Also, the controller is preferably configured to execute, as the varying process, a process in which the lower the vehicle speed at the time when the accelerator operating member and the brake operating member are simultaneously operated is, the greater a reduction amount by which the driving power is lowered per unit time during execution of the gradual change process becomes.

In this configuration, the gradual change process is executed for gradually reducing the driving power in a period from when simultaneous operation of the accelerator operating member and the brake operating member is performed to when the driving power limiting process is started. Such execution of the gradual change process prior to the driving power limiting process restrains the driving power from being rapidly dropped due to execution of the driving power limiting process. At execution of the gradual change process, the greater the reduction amount of the driving power per unit time is, the shorter the time required for sufficiently lowering the driving power in preparation for the driving power limiting process becomes. Thus, in this configuration, the lower the vehicle speed is at the time when simultaneous operation of the accelerator operating member and the brake operating member is performed, the greater the reduction amount of the driving power per unit time during execution of the gradual change process becomes. Therefore, the lower the vehicle speed is at the time when the accelerator operating member and the brake operating member are simultaneously operated, the shorter can be made the period from when the accelerator operating member and the brake operating member are simultaneously operated to when the driving power limiting process is started.

The above described vehicle control device may include a measuring section adapted for measuring an inter-vehicle distance. The controller is preferably configured such that, when the inter-vehicle distance is greater than or equal to a predetermined value, the controller prohibits execution of the varying process and sets a period from when the accelerator operating member and the brake operating member are simultaneously operated to when the driving power limiting process is started to a time longer than or equal to a longest time that is obtained when the varying process is executed.

When the inter-vehicle distance, which is the distance from the host vehicle to another vehicle present in the traveling direction of the host vehicle, is greater than or equal to the predetermined value so that the driver has sufficient time to perform the brake operation, the period from when the accelerator operating member and the brake operating member are simultaneously operated to when the driving power limiting process is started can be extended to a certain extent, thereby prioritizing drivability.

Thus, in this configuration, execution of the varying process is prohibited when the inter-vehicle distance is greater than or equal to the predetermined value. In this regard, the period from when the accelerator operating member and the brake operating member are simultaneously operated to when the driving power limiting process is started is set to a time longer than or equal to the longest time that is obtained when the varying process is executed. Thus, when the driver has sufficient time to perform brake operation, the period from when the accelerator operating member and the brake operating member are simultaneously operated to when the driving power limiting process is started is set to be longer than or equal to the longest time that is obtained when the varying process is executed. Therefore, at execution of the driving power limiting process, drivability can be prioritized if the driver has sufficient time to perform brake operation.

The vehicle control device may include a measuring section adapted for measuring an inter-vehicle distance. The controller is preferably configured such that, when the inter-vehicle distance is less than or equal to a predetermined value, the controller prohibits execution of the varying process and sets a period from when the accelerator operating member and the brake operating member are simultaneously operated to when the driving power limiting process is started to a time shorter than or equal to a shortest time that is obtained when the varying process is executed.

When the inter-vehicle distance, which is the distance from the host vehicle to another vehicle present in the traveling direction of the host vehicle, is shorter than or equal to the predetermined value so that the deceleration of the vehicle needs to be quickly increased, the period from when the accelerator operating member and the brake operating member are simultaneously operated to when the driving power limiting process is started is preferably minimized to prioritize vehicle deceleration over drivability.

Thus, in this configuration, execution of the varying process is prohibited when the inter-vehicle distance is less than or equal to the predetermined value. In this regard, the period from when the accelerator operating member and the brake operating member are simultaneously operated to when the driving power limiting process is started is set to a time shorter than or equal to the shortest time that is obtained when the varying process is executed. Thus, when the inter-vehicle distance is short and the deceleration of the vehicle needs to be quickly increased, the period from when the accelerator operating member and the brake operating member are simultaneously operated to when the driving power limiting process is started is set to be shorter than or equal to the shortest time that is obtained when the varying process is executed. Therefore, at execution of the driving power limiting process, when the inter-vehicle distance is short to an extent that requires a quick increase in the vehicle deceleration, the vehicle deceleration can be increased early.

### BRIEF DESCRIPTION OF THE DRAWINGS

FIG. 1 is a schematic diagram showing the structure of a hybrid vehicle equipped with a vehicle control device according to a first embodiment;

FIG. 2 is a timing diagram showing an overview of a brake override system according to the first embodiment;

FIG. 3 is a flowchart showing a procedure of the brake override system according to the first embodiment;

FIG. 4 is a conceptual diagram showing the relationship between the vehicle speed and the delay time according to the first embodiment;

FIG. 5 is a conceptual diagram showing the relationship between the vehicle speed and the reduction amount according to the first embodiment;

FIG. 6 is a timing diagram showing changes in the delay process time and the gradual change process time according to the first embodiment;

FIG. 7 is a flowchart showing a part of the procedure of the brake override system according to a second embodiment;

FIG. 8 is a timing diagram showing an overview of a brake override system according to a modification of the first and second embodiments;

FIG. 9 is a timing diagram showing an overview of a brake override system according to a modification of the first and second embodiments;

FIG. 10 is a timing diagram showing an overview of a brake override system according to a modification of the first and second embodiments; and

FIG. 11 is a timing diagram showing an overview of a brake override system according to a modification of the first and second embodiments.

### MODES FOR CARRYING OUT THE INVENTION

### First Embodiment

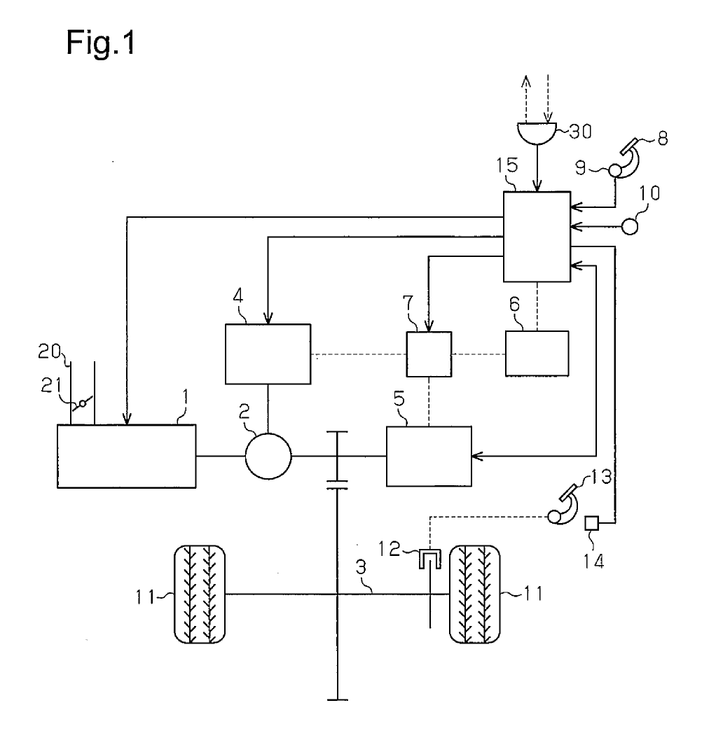

A vehicle control device according to a first embodiment will now be described with reference to FIGS. 1 to 6. In the first embodiment, the vehicle control device is mounted in a hybrid vehicle that has an engine and a motor as drive sources.

FIG. 1 shows a hybrid vehicle that includes an engine 1. The engine 1 has an intake passage 20 for introducing air into cylinders. The intake passage 20 includes a throttle valve 21 for regulating the intake air amount. The opening degree of the throttle valve 21 is adjusted to control the output of the engine 1.

The driving power output from the engine 1 is split by a power split device 2, which includes planetary gears, into driving power transmitted to a drive shaft 3 of the vehicle and driving power transmitted to a first motor-generator 4. The drive shaft 3 of the vehicle also receives driving power output by a second motor-generator 5. The driving power transmitted to the drive shaft 3 rotates wheels 11 coupled to the drive shaft 3, which causes the vehicle to travel. The vehicle also includes a brake device 12, which applies brakes on the rotation of the wheels 11, thereby decelerating the vehicle.

The first motor-generator 4, which functions mainly as a generator, also functions as a motor depending on the driving state of the vehicle. The second motor-generator 5, which functions mainly as a motor, also functions as a generator depending on the driving state of the vehicle. The vehicle includes an inverter 7 that controls transmission of electricity between the first and second motor-generators 4, 5 and a battery 6. The inverter 7, for example, supplies electricity generated by the first motor-generator 4, which mainly functions as a generator, to the battery 6, thereby charging the battery 6. The inverter 7 also supplies electricity from the battery 6 to the second motor-generator 5, which mainly functions as a motor.

The vehicle has an electronic control unit 15, which serves as a controller. The electronic control unit 15 includes a CPU, which executes computation processes for controlling the above-mentioned devices, a ROM that stores programs and data required for the control, a RAM that temporarily stores, for example, computation results of the CPU, and input/output ports for receiving and outputting signals from and to the outside.

The electronic control unit 15 receives through the input port signals from various sensors shown below, for example.

An accelerator position sensor 9 detects the amount of operation of the accelerator pedal (an accelerator operating member) operated by the driver of the vehicle, or an accelerator operation amount ACCP.

A vehicle speed sensor 10 detects the speed of the vehicle (vehicle speed SP).

A brake sensor 14 detects the amount of operation of the brake pedal (a brake operating member) operated by the driver of the vehicle, or a brake operation amount B. The greater the brake operation amount B is, the greater the braking force of the brake device 12 becomes.

A measuring section 30 measures an inter-vehicle distance D, which is the distance from the host vehicle to another vehicle present in the traveling direction of the host vehicle. The measuring section 30 may be a radar that uses microwaves, ultrasonic waves, or laser.

The electronic control unit 15 is connected through the output port to the drive circuits of various devices for operating the engine 1, the drive circuit of the first motor-generator 4, the drive circuit of the second motor-generator 5, and the driver circuit of the inverter 7.

The electronic control unit 15 computes a target driving power P of the vehicle based on the engine operating state such as the vehicle speed SP and the accelerator operation amount ACCP. The electronic control unit 15 controls the driving power output by the engine 1 and the driving power output by the second motor-generator 5 to gain the computed target driving power P. Such control of the engine 1 and the second motor-generator 5 is executed while taking into consideration minimization of the energy consumption.

The electronic control unit 15 includes a brake override system, which is one of the control procedures for controlling the driving power of the vehicle. The brake override system executes a driving power limiting process for reducing the driving power output by the drive sources when the accelerator pedal 8 and the brake pedal 13 are operated simultaneously compared to when only the accelerator pedal 8 is operated.

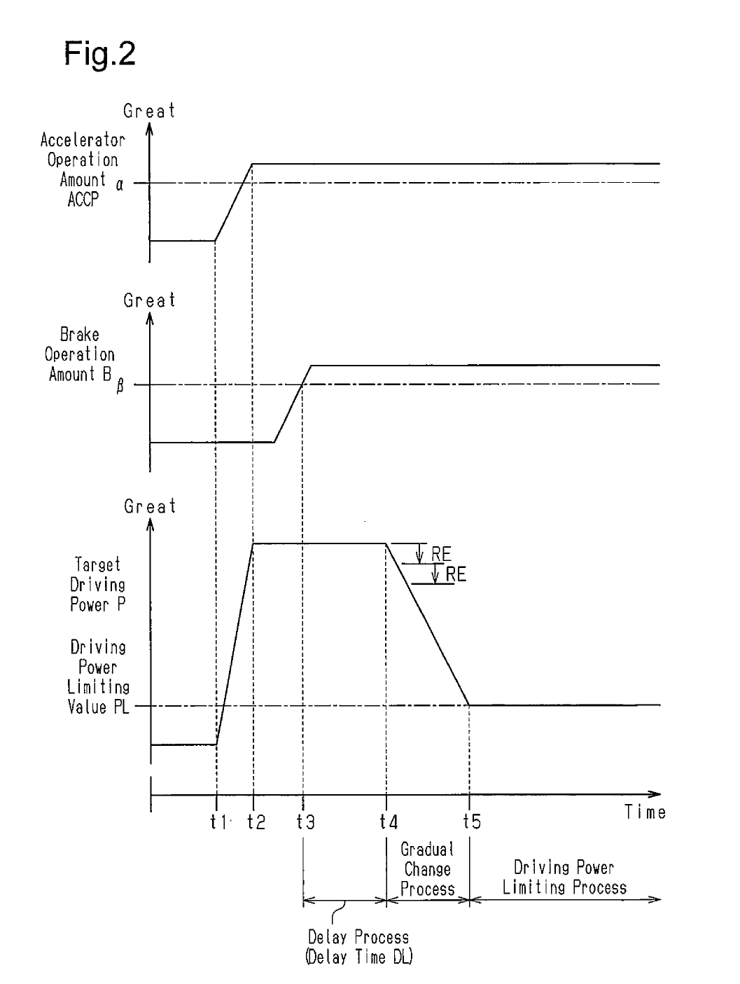

FIG. 2 shows an overview diagram of the brake override system. As shown in FIG. 2, when the accelerator operation amount ACCP is greater than a predetermined accelerator determination value α and the brake operation amount B is greater than a predetermined brake determination value β (at or after a point in time t3), the electronic control unit 15 determines that the accelerator pedal 8 and the brake pedal 13 are being simultaneously operated.

If the driving power limiting process is executed immediately after it is determined that the accelerator pedal 8 and the brake pedal 13 are being simultaneously operated, drivability may be adversely affected.

For example, if simultaneous operation of the accelerator pedal 8 and the brake pedal 13 is accidental and not intended by the driver, immediate execution of the driving power limiting process results in deceleration of the vehicle despite the absence of driver's intention for deceleration, causing drivability to deteriorate. In this regard, when determining at the point in time t3 that the accelerator pedal 8 and the brake pedal 13 are being simultaneously operated, the electronic control unit 15 executes a delay process as a process for securing time for determining that the simultaneous operation of the accelerator pedal 8 and the brake pedal 13 is not accidental but intended by the driver.

At or after the point in time t3, in the delay process, a duration time KT is measured, during which the accelerator operation amount ACCP is greater than the accelerator determination value α and the brake operation amount B is greater than the brake determination value β, that is, the accelerator pedal 8 and the brake pedal 13 are operated simultaneously. When the measured duration time KT reaches a predetermined delay time DL (a point in time t4), the electronic control unit 15 determines that the simultaneous operation of the accelerator pedal 8 and the brake pedal 13 is not accidental but is intended by the driver and determines that an execution condition for the driving power limiting process is met. In contrast, if the measurement of the duration time KT is stopped before the delay time DL elapses, that is, if, during the delay process, the accelerator operation amount ACCP falls to or below the accelerator determination value α or if the brake operation amount B falls to or below the brake determination value β, the simultaneous operation of the accelerator pedal 8 and the brake pedal 13 is determined to be accidental. In this case, the execution condition for the driving power limiting process is determined to be not met.

The execution of the delay process, in which the above described determination is made, restrains an unintentional drop of the driving power when a simultaneous operation of the accelerator pedal 8 and the brake pedal 13 is accidental. This prevents drivability from deteriorating.

If the driving power limiting process is executed to significantly reduce the driving power immediately after simultaneous operation of the accelerator pedal 8 and the brake pedal 13 is performed, the vehicle deceleration is rapidly increased. This also adversely affects drivability. In this regard, the electronic control unit 15 executes a gradual change process for gradually reducing the driving power in a period from when the accelerator pedal 8 and the brake pedal 13 are simultaneously operated to when the driving power limiting process is started. In the gradual change process, if the execution condition for the driving power limiting process is determined to be met at the point in time t4, the driving power at the point in time t4, that is, the driving power before the start of the driving power limiting process, is gradually reduced toward a low driving power that will be achieved by the driving power limiting process. More specifically, a predetermined reduction amount RE is repeatedly subtracted from the target driving power P, which is set at the point in time t4, so that the actual vehicle driving power is gradually reduced. When the target driving power P reaches a driving power limiting value PL, which is determined in the driving power limiting process (a point in time t5), the gradual change process for the driving power is ended. In this manner, the gradual change process for gradually reducing the driving power is executed in a period from simultaneous operation of the accelerator pedal 8 and the brake pedal 13 to the start of the driving power limiting process. That is, the gradual change process is executed prior to execution of the driving power limiting process. This restrains the driving power from being rapidly dropped, thereby limiting deterioration of drivability due to a rapid increase in the vehicle deceleration.

When the gradual change process is ended at the point in time t5, the driving power limiting process is executed for prioritizing the brake operation. In the driving power limiting process, the driving power limiting value PL is set to limit the driving power. The driving power limiting value PL is the upper limit value of the target driving power P. If the computed target driving power P is greater than the driving power limiting value PL, the driving power limiting value PL is set as the target driving power P. Therefore, during the execution of the driving power limiting process, the driving power of the vehicle is limited to be less than or equal to the driving power limiting value PL. The driving power limiting value PL is set to a value that allows the driving power of the vehicle to be sufficiently small in relation to the braking force of the brake device 12 at simultaneous operation of the accelerator pedal 8 and the brake pedal 13. This causes the brake operation to be prioritized even at simultaneous operation of the accelerator pedal 8 and the brake pedal 13.

If the delay process or the gradual change process is executed prior to the execution of the driving power limiting process, the time at which the driving power limiting process is executed is delayed compared to the case in which the driving power limiting process is executed immediately after simultaneous operation of the accelerator pedal 8 and the brake pedal 13 is performed. This extends the time required for the driving power to be sufficiently reduced at simultaneous operation of the accelerator pedal 8 and the brake pedal 13. Thus, when the accelerator pedal 8 and the brake pedal 13 are simultaneously operated, the braking distance of the vehicle tends to be longer than when normal brake operation is performed, that is, when only the brake pedal 13 is operated. Therefore, to stop the vehicle at a position predicted by the driver at simultaneous operation of the accelerator pedal 8 and the brake pedal 13, the driver must increase the amount of operation of the brake pedal 13 compared to the normal brake operation. This complicates the brake operation by the driver.

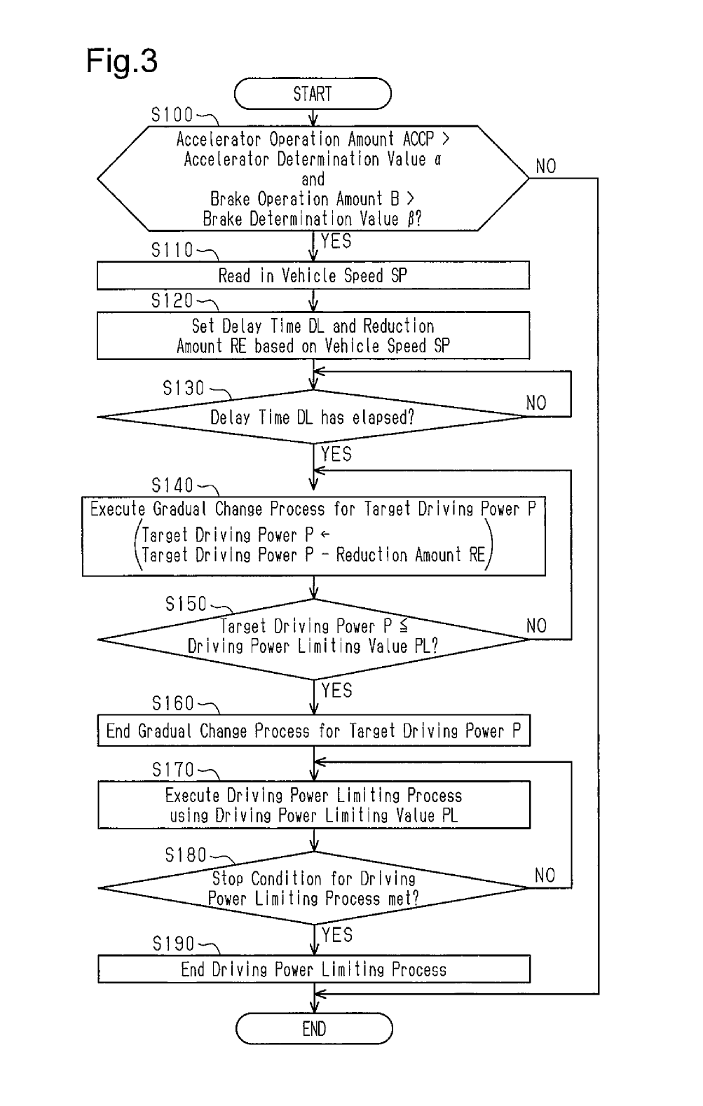

In this regard, in the present embodiment, when executing the driving power limiting process at simultaneous operation of the accelerator pedal 8 and the brake pedal 13, a procedure in the brake override system shown in FIG. 3 is executed to facilitate the brake operation performed by the driver.

As shown in FIG. 3, the electronic control unit 15 first determines whether the accelerator operation amount ACCP is greater than the accelerator determination value α and the brake operation amount B is greater than the brake determination value β (S100). If the outcome of step S100 is negative (S100: NO), the electronic control unit 15 temporarily suspends the process and executes step S100 in the next execution cycle.

If the outcome of step S100 is positive, the electronic control unit 15 reads in the vehicle speed SP of a time at which the accelerator pedal 8 and the brake pedal 13 are operated simultaneously (S110). Specifically, the electronic control unit 15 reads in the vehicle speed SP of a time at which the condition is met that the accelerator operation amount ACCP is greater than the accelerator determination value α and the brake operation amount B is greater than the brake determination value β.

Next, based on the vehicle speed SP read in at step S110, the electronic control unit 15 sets the delay time DL, which is used in the delay process, and a reduction amount RE (S120). The reduction amount RE is an amount by which the driving power is lowered per unit time during the execution of the gradual change process. Specifically, the reduction amount RE is subtracted from the target driving power P. Step S120 corresponds to the varying process.

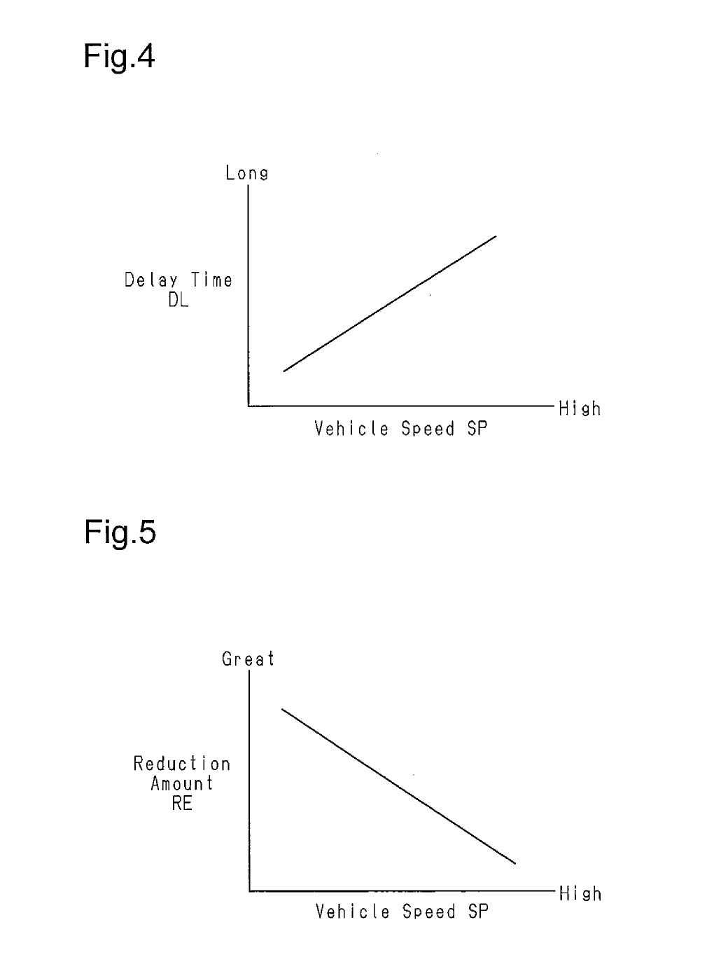

As shown in FIG. 4, the lower the vehicle speed SP, which has been read in at step S110, is, the shorter the delay time DL is set to be.

As shown in FIG. 5, the lower the vehicle speed SP, which has been read in at step S110, is, the greater the reduction amount RE is set to be.

Then, the electronic control unit 15 determines whether the delay time DL, which has been set at step S120, has elapsed, that is, whether the duration time KT has reached the delay time S120, which has been set at step S120 (S130). If the delay time DL has not elapsed (S130: NO), the electronic control unit 15 repeats step S130 until the delay time DL elapses. If the measurement of the duration time KT is stopped during repetitive execution of step S130, the electronic control unit 15 determines that the positive outcome of step S100 was caused by an accidental operation and that the execution condition for the driving power limiting process is not met.

In contrast, when the delay time DL has elapsed (S130:YES), the electronic control unit 15 determines that the execution condition for the driving power limiting process is met and executes the gradual change process for the target driving power P (S140). At step S140, the reduction amount RE, which has been set at step S120, is subtracted from the currently set target driving power P to renew the target driving power P.

Next, the electronic control unit 15 determines whether the target driving power P renewed at step S140 is less than or equal to the driving power limiting value PL (S150). If the target driving power P is greater than the driving power limiting value PL (S150: NO), the electronic control unit 15 repeatedly executes step S140, or the gradual change process for the target driving power P, until the target driving power P falls to or below the driving power limiting value PL.

If the target driving power P is less than or equal to the driving power limiting value PL (S150:YES), the electronic control unit 15 ends the gradual change process for the target driving power P (S160).

Subsequently, the electronic control unit 15 executes the driving power limiting process by using the driving power limiting value PL (S170).

Next, the electronic control unit 15 determines whether a stop condition for the driving power limiting process is met (S180). The stop condition is set as a case in which it is possible to determine whether the driving power limiting process no longer needs to be executed. For example, the stop condition may be a case in which the accelerator operation amount ACCP has become zero or a case in which the brake operation amount B has become 0.

When the stop condition for the driving power limiting process is not met (S180: NO), steps S170 to S180 are sequentially executed.

In contrast, when the stop condition for the driving power limiting process is met (S180: YES), the electronic control unit 15 ends the execution of the driving power limiting process, that is, terminates limitation on the target driving power P by the driving power limiting value PL (S190) and ends the current process.

Operation of the brake override system according to the present embodiment will now be described.

When the normal brake operation, in which only the brake pedal 13 is operated, is executed, the lower the vehicle speed SP is, the shorter the braking distance becomes, in general. Thus, the lower the vehicle speed SP is, the smaller the brake operation amount by the driver becomes. Therefore, even when the driving power limiting process is executed, a lower vehicle speed SP possibly results in a smaller brake operation amount by the driver. To maintain drivability, the driving power limiting process is executed after a certain period of time has elapsed from the point in time at which the accelerator pedal 8 and the brake pedal 13 are simultaneously operated. That is, the driving power limiting process is executed after the delay process and the gradual change process are executed.

In a case in which the driving power limiting process is started after a certain period of time has elapsed from when simultaneous operation of the accelerator pedal 8 and the brake pedal 13 is performed, the braking distance of the vehicle tends to be longer than that in the normal brake operation, in which only the brake pedal 13 is operated. Particularly, in low vehicle speed regions, in which the brake operation amount is small, the braking distance tends to be longer. Thus, the lower the vehicle speed SP is at the time when simultaneous operation of the accelerator pedal 8 and the brake pedal 13 is performed, the more frequently the brake operation amount is increased and the greater the increase amount of the brake operation amount becomes to stop the vehicle at a position predicted by the driver.

In this respect, in the present embodiment, the varying process is executed, in which the delay time DL and the reduction amount RE are varied based on the vehicle speed SP.

In the varying process, the lower the vehicle speed SP is at the time when simultaneous operation of the accelerator pedal 8 and the brake pedal 13 is performed, the shorter the delay time DL is set to be.

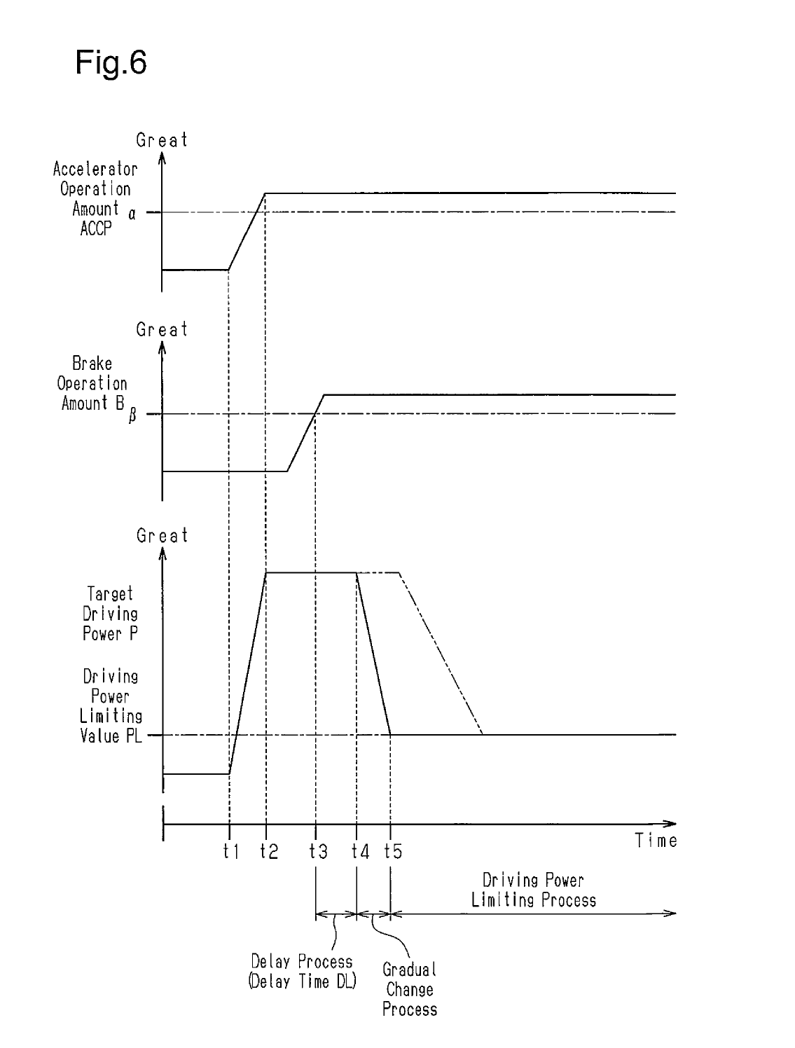

When the vehicle speed SP at simultaneous operation of the accelerator pedal 8 and the brake pedal 13 is low, the delay time DL is set to be short as indicated by the solid line in FIG. 6 compared to the case in which the vehicle speed SP is high at simultaneous operation of the accelerator pedal 8 and the brake pedal 13 as indicated by the long dashed double-short dashed line in FIG. 6. Accordingly, the gradual change process is started earlier (point in time t4). Thus, when the vehicle speed SP is low, the gradual change process is ended earlier (point in time t5) than when the vehicle speed SP is high. As a result, the driving power limiting process is started earlier (point in time t5). As described above, in the varying process, the lower the vehicle speed SP is at the time when simultaneous operation of the accelerator pedal 8 and the brake pedal 13 is performed, the shorter the delay time DL is set to be. Therefore, the lower the vehicle speed SP is at the simultaneous operation of the accelerator pedal 8 and the brake pedal 13, the shorter the period from when the accelerator pedal 8 and the brake pedal 13 are simultaneously operated to when the driving power limiting process is started becomes.

At execution of the gradual change process, the greater the reduction amount RE is, the shorter the time required for sufficiently lowering the driving power in preparation for the driving power limiting process becomes. In other words, the greater the reduction amount RE is, the shorter the time required for the target driving power P to drop to the driving power limiting value PL prior to execution of the gradual change process becomes. Thus, in the varying process of step S120, the lower the vehicle speed SP is at the time when simultaneous operation of the accelerator pedal 8 and the brake pedal 13 is performed, the greater the reduction amount RE is set to be.

When the vehicle speed SP at simultaneous operation of the accelerator pedal 8 and the brake pedal 13 is low, the reduction amount RE is increased as indicated by the solid line in FIG. 6 compared to the case in which the vehicle speed SP is high at simultaneous operation of the accelerator pedal 8 and the brake pedal 13 as indicated by the long dashed double-short dashed line in FIG. 6. Accordingly, the gradual change process is ended earlier (point in time t5). Thus, when the vehicle speed SP is low, the driving power limiting process is started earlier (point in time t5) than when the vehicle speed is high. In this manner, the lower the vehicle speed SP is at the time when simultaneous operation of the accelerator pedal 8 and the brake pedal 13 is performed, the greater the reduction amount RE is set to be. Therefore, the lower the vehicle speed SP is at the simultaneous operation of the accelerator pedal 8 and the brake pedal 13, the shorter the period from when the accelerator pedal 8 and the brake pedal 13 are simultaneously operated to when the driving power limiting process is started becomes.

Through execution of the varying process, the lower the vehicle speed SP is at the time when simultaneous operation of the accelerator pedal 8 and the brake pedal 13 is performed, the earlier the time at which the driving power limiting process is started. Thus, the lower the vehicle speed SP is, the shorter the time required for the driving power to be sufficiently reduced becomes at the simultaneous operation of the accelerator pedal 8 and the brake pedal 13. Therefore, when the accelerator pedal 8 and the brake pedal 13 are simultaneously operated, the lower the vehicle speed SP is, the earlier the time at which the deceleration of the vehicle is increased becomes. Thus, in low vehicle speed regions, it is possible to stop the vehicle at a position predicted by the driver, while limiting the increase in the brake operation amount by the driver. This simplifies the brake operation by the driver at the execution of the drive force limiting process when the accelerator pedal 8 and the brake pedal 13 are simultaneously operated.

The driver is aware that when the vehicle speed SP is high, the braking distance will be long compared to when the vehicle speed SP is low. Therefore, when the vehicle speed SP is high, the brake operation amount B is often greater from the beginning than when the vehicle speed SP is low. Also, the driver often operates the brake pedal 13 with the intention of increasing the brake operation amount B during deceleration of the vehicle. Therefore, when the vehicle speed SP is high, the driver is less likely to feel that the operation of the brake pedal 13 is complicated than when the vehicle speed SP is low. In this respect, the delay time DL when the vehicle speed SP is high is set to be longer than that when the vehicle speed SP is low in the present embodiment. It is thus possible to secure sufficient time for determining whether simultaneous operation of the accelerator pedal 8 and the brake pedal 13 is accidental or intended by the driver, so that the accuracy of such determination is improved. It is thus possible to restrain an unintentional drop of the driving power when a simultaneous operation of the accelerator pedal 8 and the brake pedal 13 is accidental. This prevents drivability from deteriorating.

Also, in the present embodiment, the reduction amount RE when the vehicle speed SP is high is set to be smaller than that when the vehicle speed SP is low. Thus, the higher the vehicle speed SP is, the lower the rate at which the driving power is reduced during execution of the gradual change process becomes. Therefore, the higher the vehicle speed SP is, the more reliably deterioration of drivability due to an abrupt change of the driving power is suppressed.

As described above, the present embodiment has the following advantages.

(1) The varying process is executed, in which the lower the vehicle speed SP is at the simultaneous operation of the accelerator pedal 8 and the brake pedal 13, the shorter the period from when the accelerator pedal 8 and the brake pedal 13 are simultaneously operated to when the driving power limiting process is started becomes. Therefore, when the accelerator pedal 8 and the brake pedal 13 are simultaneously operated, the lower the vehicle speed SP is, the earlier the time at which the deceleration of the vehicle is increased becomes. Thus, in low vehicle speed regions, it is possible to stop the vehicle at a position predicted by the driver, while limiting the increase in the brake operation amount by the driver. Therefore, it is possible to simplify the brake operation by the driver at the execution of the driving power limiting process when the accelerator pedal 8 and the brake pedal 13 are simultaneously operated.

(2) The driving power limiting process is started after the delay time DL has elapsed from when simultaneous operation of the accelerator pedal 8 and the brake pedal 13 is performed. As the varying process, a process is executed in which the lower the vehicle speed SP is at the time when simultaneous operation of the accelerator pedal 8 and the brake pedal 13 is performed, the shorter the delay time DL is set to be. This allows the varying process to be reliably executed, in which the lower the vehicle speed SP is at the simultaneous operation of the accelerator pedal 8 and the brake pedal 13, the shorter the period from when the accelerator pedal 8 and the brake pedal 13 are simultaneously operated to when the driving power limiting process is started becomes.

(3) The gradual change process is executed for gradually reducing the driving power in a period from when simultaneous operation of the accelerator pedal 8 and the brake pedal 13 is started to when the driving power limiting process is started. The varying process is executed, in which the lower the vehicle speed SP is at the time when simultaneous operation of the accelerator pedal 8 and the brake pedal 13 is performed, the greater reduction amount RE (the amount by which the driving power is lowered per unit time during the execution of the gradual change process). This allows the varying process to be reliably executed, in which the lower the vehicle speed SP is at the simultaneous operation of the accelerator pedal 8 and the brake pedal 13 is, the shorter the period from when the accelerator pedal 8 and the brake pedal 13 are simultaneously operated to when the driving power limiting process is started becomes.

### Second Embodiment

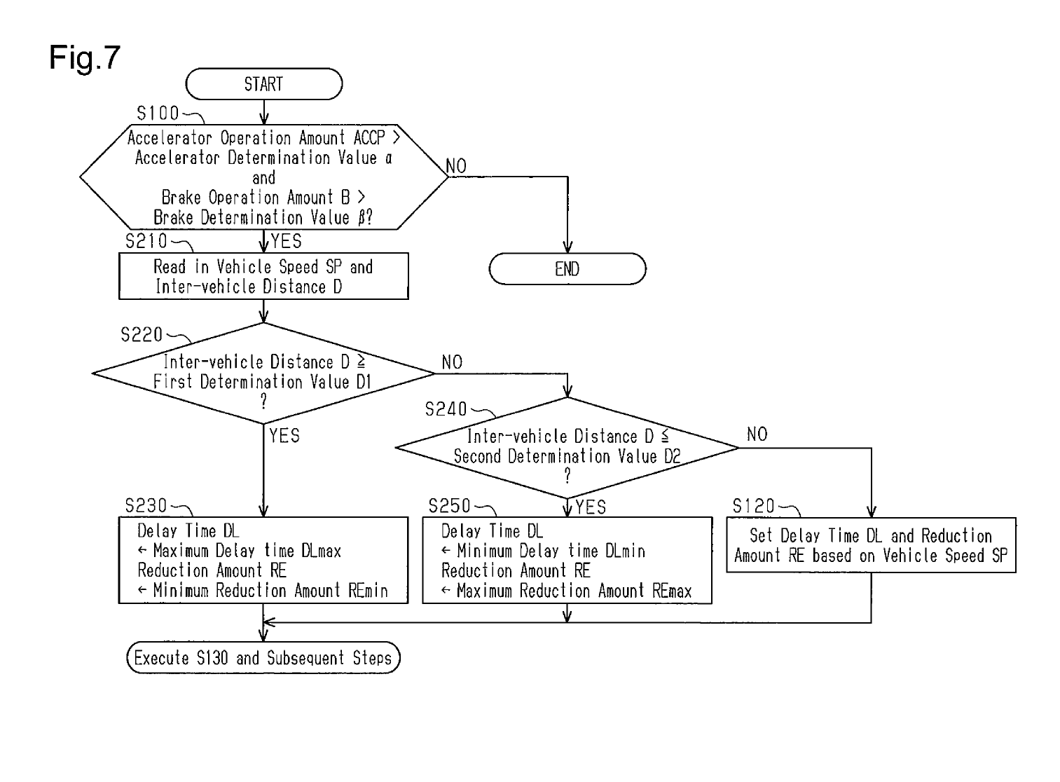

A vehicle control device according to a second embodiment will now be described with reference to FIG. 7.

In the present embodiment, the inter-vehicle distance D is taken into consideration at execution of the brake override system, and the procedure in FIG. 3 is changed partially. The vehicle control device of the present embodiment will be described focusing on such differences.

As shown in FIG. 7, the electronic control unit 15 first determines whether the accelerator operation amount ACCP is greater than the accelerator determination value α and the brake operation amount B is greater than the brake determination value β (S100). If the outcome of step S100 is negative (S100: NO), the electronic control unit 15 temporarily suspends the process and executes step S100 in the next execution cycle.

If the outcome of step S100 is positive, the electronic control unit 15 reads in the vehicle speed SP and the inter-vehicle distance D at the time at which the accelerator pedal 8 and the brake pedal 13 are operated simultaneously (S210).

Next, the electronic control unit 15 determines whether the inter-vehicle distance D read in at step S210 is greater than or equal to a first determination value D1 (S220). The first determination value D1 is set to a value that indicates that the host vehicle and another vehicle present in the traveling direction of the host vehicle is sufficient and allows for sufficient time for the driver to perform brake operation.

When the inter-vehicle distance D is greater than or equal to the first determination value D1 (S220: YES), the electronic control unit 15 sets a maximum delay time DLmax as the delay time DL and sets a minimum reduction amount REmin as the reduction amount RE (S230). The electronic control unit 15 sequentially executes the procedure following step S130 shown in FIG. 3, that is, the delay process, the gradual change process, and the driving power limiting process.

The maximum delay time DLmax is a fixed value that is set in advance and is at least longer than or equal to the maximum value of the delay time DL, which is varied through the varying process. The minimum reduction amount REmin is also a fixed value that is set in advance and is at least less than or equal to the minimum value of the reduction amount RE, which is varied through the varying process.

When the inter-vehicle distance D is greater than or equal to the first determination value D1, varying of the delay time DL and the reduction amount RE based on the vehicle speed SP is prohibited. That is, execution of the varying process based on the vehicle speed SP is prohibited. In this case, the previously prepared maximum delay time DLmax is set as the delay time DL, and the previously prepared minimum reduction amount REmin is set as the reduction amount RE.

If the inter-vehicle distance D is determined to be less than the first determination value D1 at step S220 (S220: NO), the electronic control unit 15 determines whether the inter-vehicle distance D is less than or equal to a second determination the second determination value D2 (S240). The second determination value D2 is set to a distance that is shorter than the first determination value D1 and indicates that the inter-vehicle distance D is so short that quick increase in the vehicle deceleration is required at simultaneous operation of the accelerator pedal 8 and the brake pedal 13.

When the inter-vehicle distance D is less than or equal to the second determination value D2 (S240: YES), the electronic control unit 15 sets a minimum delay time DLmin as the delay time DL and sets a maximum reduction amount REmax as the reduction amount RE (S250). The electronic control unit 15 sequentially executes the procedure following step S130 shown in FIG. 3, that is, the delay process, the gradual change process, and the driving power limiting process.

The minimum delay time DLmin is a fixed value that is set in advance and is at least less than or equal to the minimum value of the delay time DL, which is varied through the varying process. The maximum reduction amount REmax is also a fixed value that is set in advance and is at least greater than or equal to the maximum value of the reduction amount RE, which is varied through the varying process.

When the inter-vehicle distance D is less than or equal to the second determination value D2, varying of the delay time DL and the reduction amount RE based on the vehicle speed SP is prohibited. That is, execution of the varying process based on the vehicle speed SP is prohibited. In this case, the previously prepared minimum delay time DLmin is set as the delay time DL, and the previously prepared maximum reduction amount REmax is set as the reduction amount RE.

If the inter-vehicle distance D is determined to be greater than the second determination value D2 at step S240, that is, if the inter-vehicle distance D is between the first determination value D1 and the second determination value D2 (S240: NO), the electronic control unit 15 executes step S120 in FIG. 3. Specifically, the varying process is executed, in which the delay time DL and the reduction amount RE are varied based on the vehicle speed SP at the time when simultaneous operation of the accelerator pedal 8 and the brake pedal 13 is performed. The electronic control unit 15 then sequentially executes the procedure following step S130 shown in FIG. 3, that is, the delay process, the gradual change process, and the driving power limiting process.

Operation of the brake override system according to the present embodiment will now be described.

When the inter-vehicle distance, which is the distance from the host vehicle to another vehicle present in the traveling direction of the host vehicle, is sufficiently long, so that the driver has sufficient time to perform brake operation, the period from when the accelerator pedal 8 and the brake pedal 13 are simultaneously operated to when the driving power limiting process is started can be extended to a certain extent, thereby prioritizing securement of drivability through the delay process and the gradual change process.

In the present embodiment, when the inter-vehicle distance D is greater than or equal to the first determination value D1, that is, when the host vehicle is sufficiently separated away from another vehicle, the varying process is prohibited. The period from when the accelerator pedal 8 and the brake pedal 13 are simultaneously operated to when the driving power limiting process is started is set to a time longer than or equal to the longest time that is obtained when the varying process is executed. More specifically, the maximum delay time DLmax is set as the delay time DL, which is used in the delay process, and the minimum reduction amount REmin is set as the reduction amount RE, which is used in the gradual change process for the driving power.

Such extension of the delay time DL secures sufficient time for determining whether simultaneous operation of the accelerator pedal 8 and the brake pedal 13 is accidental or intended by the driver, so that the accuracy of such determination is improved. It is thus possible to restrain an unintentional drop of the driving power when a simultaneous operation of the accelerator pedal 8 and the brake pedal 13 is accidental. This prevents drivability from deteriorating. Also, reduction in the reduction amount RE lowers the rate at which the driving power is reduced during execution of the gradual change process. This suppresses deterioration of drivability due to an abrupt change of the driving power. Therefore, at execution of the driving power limiting process, drivability can be prioritized if the driver has sufficient time to perform brake operation.

In contrast, when the host vehicle is close to another vehicle present in the traveling direction of the host vehicle, so that the deceleration of the vehicle needs to be quickly increased, the period from when the accelerator pedal 8 and the brake pedal 13 are simultaneously operated to when the driving power limiting process is started is preferably minimized to prioritize the vehicle deceleration over drivability.

In the present embodiment, when the inter-vehicle distance D is less than or equal to the second determination value D2, that is, when the host vehicle is close to another vehicle, the varying process is prohibited. The period from when the accelerator pedal 8 and the brake pedal 13 are simultaneously operated to when the driving power limiting process is started is set to a time shorter than or equal to the shortest time that is obtained when the varying process is executed. More specifically, the minimum delay time DLmin is set as the delay time DL, which is used in the delay process, and the maximum reduction amount REmax is set as the reduction amount RE, which is used in the gradual change process for the driving power. Therefore, at execution of the driving power limiting process, when the inter-vehicle distance is short to an extent that requires a quick increase in the vehicle deceleration, the vehicle deceleration can be increased early.

As described above, the present embodiment has the following advantages in addition to the above-mentioned advantages (1) to (3).

(4) When the inter-vehicle distance D is greater than or equal to the first determination value D, the varying process for the delay time DL and the reduction amount RE based the vehicle speed SP is prohibited. The period from when the accelerator pedal 8 and the brake pedal 13 are simultaneously operated to when the driving power limiting process is started is set to a time longer than or equal to the longest time that is obtained when the varying process is executed. Therefore, at execution of the driving power limiting process, drivability can be prioritized if the driver has sufficient time to perform brake operation.

(5) When the inter-vehicle distance D is less than or equal to the second determination value, the varying process for the delay time DL and the reduction amount RE based the vehicle speed SP is prohibited. The period from when the accelerator pedal 8 and the brake pedal 13 are simultaneously operated to when the driving power limiting process is started is set to a time shorter than or equal to the shortest time that is obtained when the varying process is executed. Therefore, at execution of the driving power limiting process, when the inter-vehicle distance D is short to an extent that requires a quick increase in the vehicle deceleration, the vehicle deceleration can be increased early.

The above described embodiments may be modified as follows.

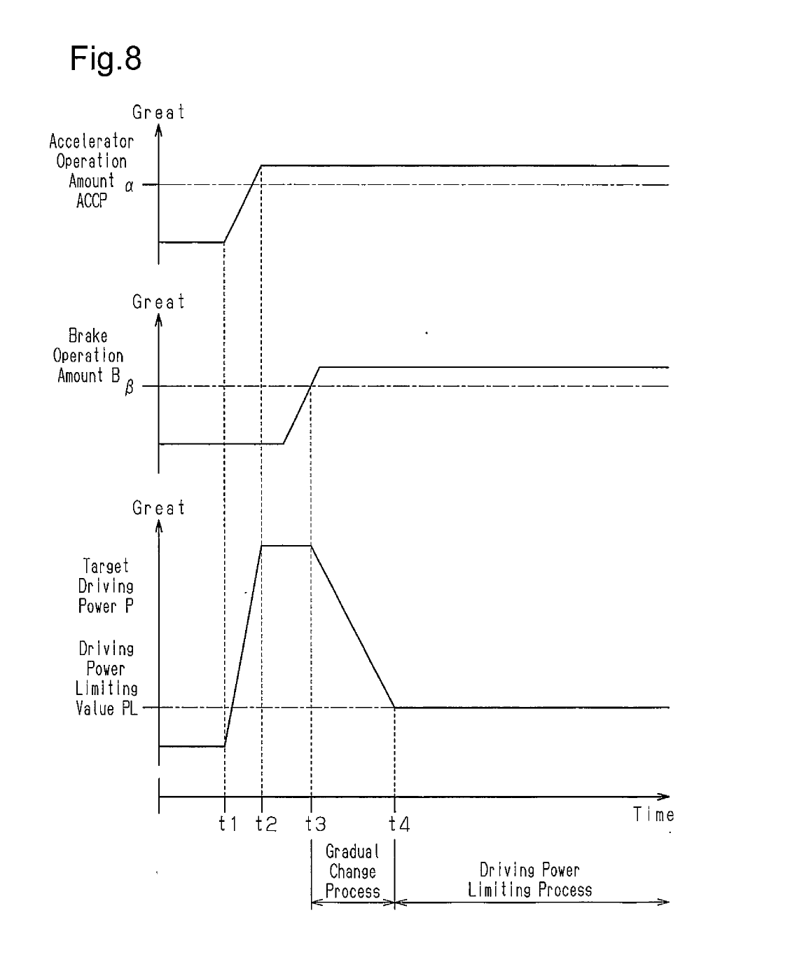

When the accelerator operation amount ACCP is greater than the accelerator determination value α, and the brake operation amount B is greater than the brake determination value β (at a point in time t3 in FIG. 8), the delay process may be omitted and the gradual change process may be executed immediately. In this case also, the above described advantages except the advantage (2) are achieved by varying the reduction amount RE based on the vehicle speed SP at step S120.

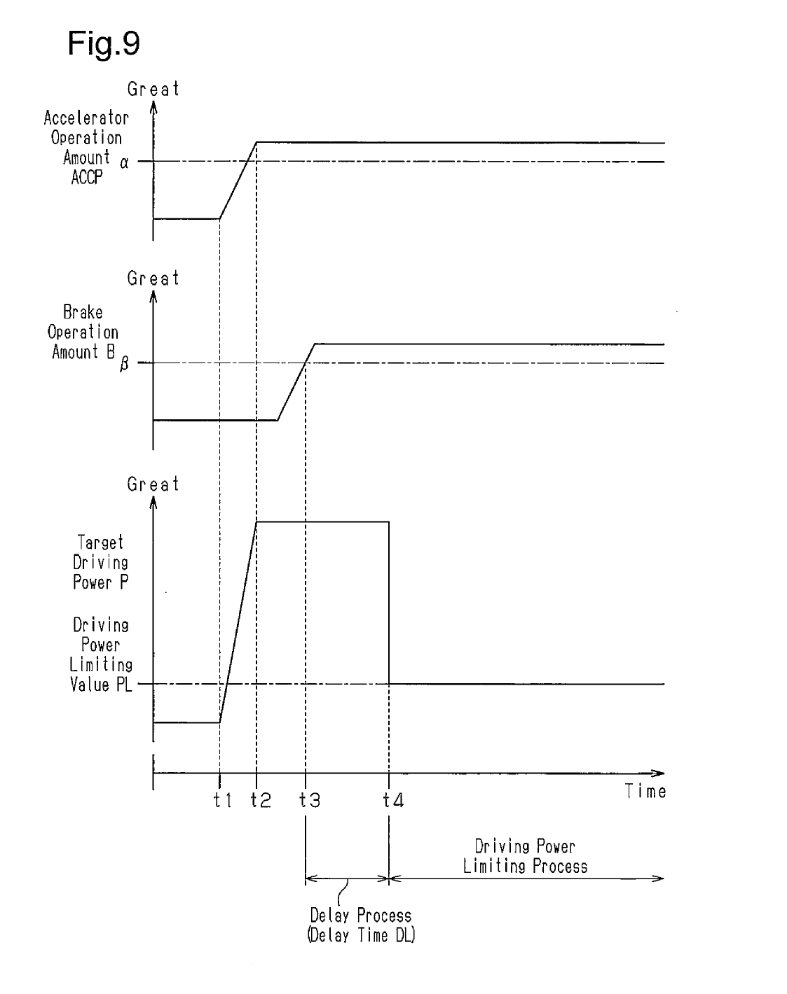

When the accelerator operation amount ACCP is greater than the accelerator determination value α, and the brake operation amount B is greater than the brake determination value β (at a point in time t3 in FIG. 9), the delay process may be started. At the point in time when the delay process is ended (a point in time t4 in FIG. 9), the driving power limiting process may be executed. That is, the gradual change process may be omitted. In this case also, the above described advantages except the advantage (3) are achieved by varying the delay time DL based on the vehicle speed SP at step S120.

In the above illustrated embodiment, the target driving power P is controlled not to exceed the driving power limiting value PL at the execution of the driving power limiting process. However, the driving power may be restricted in a different manner. For example, during the execution of the driving power limiting process, the target driving power P may always be reduced.

The vehicle in the above illustrated embodiment is a hybrid vehicle, which includes an engine and a motor as drive sources. A system similar to the above described brake override system may be mounted on a vehicle that includes only a motor as a drive source. In this case, the above described target driving power P may be used as a demanded driving power for the motor.

A system similar to the above described brake override system may be mounted on a vehicle that includes only an engine as a drive source. In such a vehicle, the driving power is adjusted by regulating the opening degree of the throttle valve 21 in accordance with the accelerator operation amount ACCP. Thus, the driving power limiting process for limiting the driving power can be executed by restricting the opening degree of the throttle valve 21.

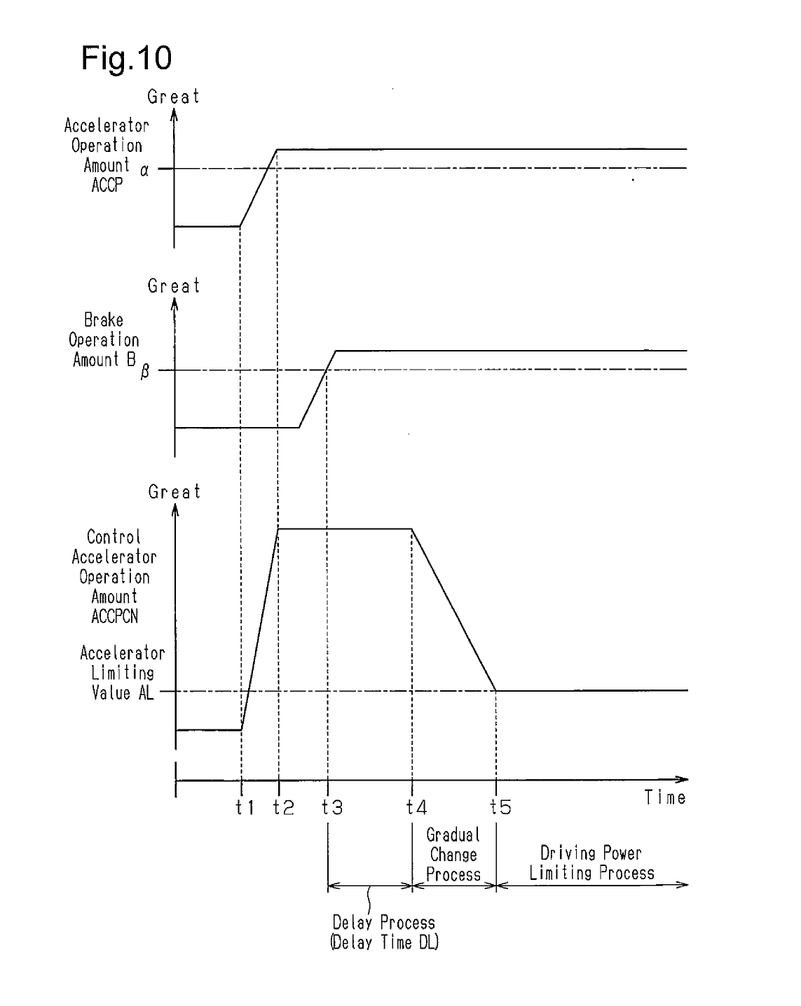

For example, the actual accelerator operation amount ACCP is compared with a demanded accelerator operation amount that has been computed through various engine control processes, and the greater one or the smaller one is set as a control accelerator operation amount ACCPCN. When setting a target opening degree of the throttle valve 21 in accordance with the control accelerator operation amount ACCPCN, the control accelerator operation amount ACCPCN is used as a value that corresponds to the target driving power P, as illustrated in FIG. 10. In the gradual change process for the driving power, the control accelerator operation amount ACCPCN is gradually reduced by using a value that corresponds to the reduction amount RE. Also, an accelerator limiting value AL is employed as a value that corresponds to the driving power limiting value PL and limits the maximum value of the control accelerator operation amount ACCPCN. In this case also, the advantages equivalent to those described above are obtained.

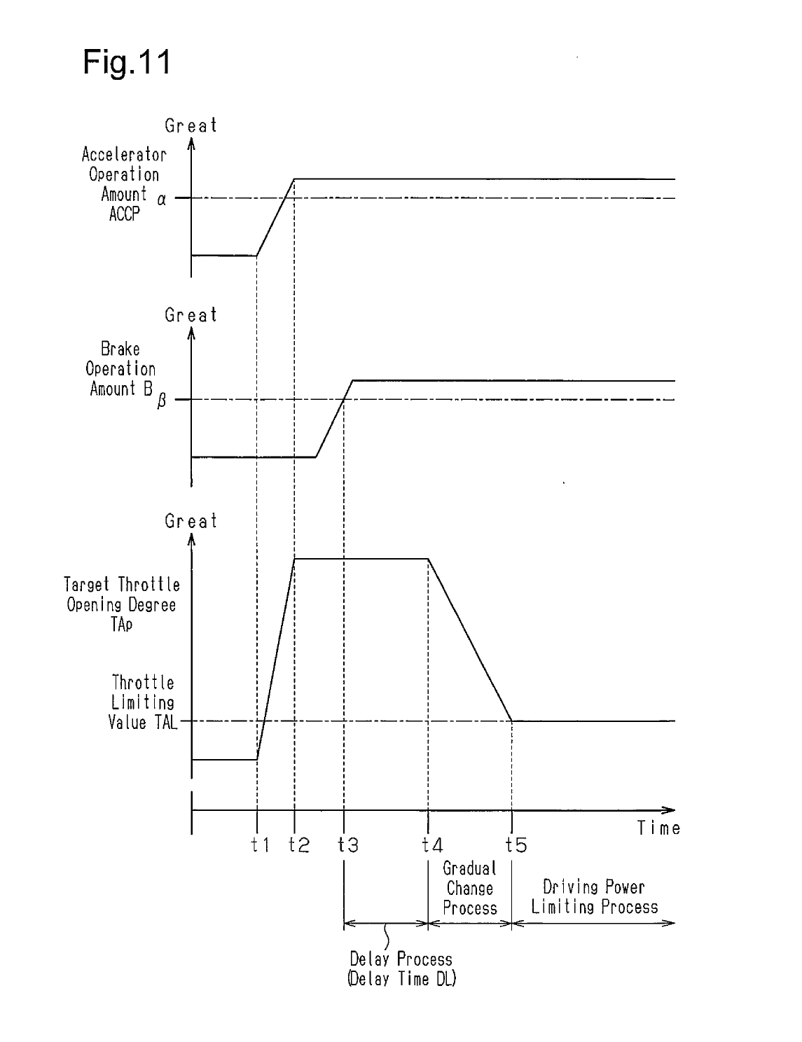

In a case in which the accelerator operation amount ACCP is reflected, without being changed, on the target throttle opening degree TAp, which is a target opening degree of the throttle valve 21, the target throttle opening degree TAp is used as a value corresponding to the target driving power P, as illustrated in FIG. 11. In the gradual change process for the driving power, the target throttle opening degree TAp is gradually reduced by using a value that corresponds to the reduction amount RE. Also, a throttle limiting value TAL is employed as a value that corresponds to the driving power limiting value PL and limits the maximum value of the target throttle opening degree TAp. In this case also, the advantages equivalent to those described above are obtained.

In the above described gradual change process, the target driving power P is decreased by the reduction amount RE at a time. However, the driving power P may be gradually reduced in a different manner. That is, if it is configured such that the lower the vehicle speed SP is at the time when the simultaneous operation of the accelerator pedal 8 and the brake pedal 13 is performed, the greater the reduction amount by which the driving power is reduced per unit time during execution of the gradual change process becomes, the same advantages as those of the above described embodiments are achieved.

The above described delay process is performed to determine whether simultaneous operation of the accelerator pedal 8 and the brake pedal 13 is accidental or intended by the driver. However, in cases in which the delay process is performed for other purposes, the same advantages as those described above are achieved by varying the delay time DL in the above described manner.

At step S230 described in the second embodiment, the maximum delay time DLmax may be set as the delay time DL and a value greater than the minimum reduction amount REmin may be set as the reduction amount RE. In this case also, by setting a sufficiently long time as the maximum delay time DLmax, the period from when the accelerator pedal 8 and the brake pedal 13 are simultaneously operated to when the driving power limiting process is started can be set to a time longer than or equal to the longest time that is obtained when the varying process is executed. Also, at step S230, a period shorter than the maximum delay time DLmax may be set as the delay time DL and the minimum reduction amount REmin may be set as the reduction amount RE. In this case also, by setting a sufficiently small amount as the minimum reduction amount REmin, the period from when the accelerator pedal 8 and the brake pedal 13 are simultaneously operated to when the driving power limiting process is started can be set to a time longer than or equal to the longest time that is obtained when the varying process is executed.

At step S250 described in the second embodiment, the minimum delay time DLmin may be set as the delay time DL and a value smaller than the maximum reduction amount REmax may be set as the reduction amount RE. In this case also, by setting a sufficiently short time as the minimum delay time DLmin, the period from when the accelerator pedal 8 and the brake pedal 13 are simultaneously operated to when the driving power limiting process is started can be set to a time shorter than or equal to the shortest time that is obtained when the varying process is executed. Also, at step S250, a period longer than the minimum delay time DLmin may be set as the delay time DL and the maximum reduction amount REmax may be set as the reduction amount RE. In this case also, by setting a sufficiently great amount as the maximum reduction amount REmax, the period from when the accelerator pedal 8 and the brake pedal 13 are simultaneously operated to when the driving power limiting process is started can be set to a time shorter than or equal to the shortest time that is obtained when the varying process is executed.

In the second embodiment, steps S240 and S250 of FIG. 7 may be omitted. If the outcome of step S220 in FIG. 7 is negative, step S120 and subsequent processes in FIG. 3 may be executed. That is, a series of processes for the case in which the inter-vehicle distance D is less than or equal to the second determination value D2 may be omitted. In this case also, the advantages except for the advantage (5) are obtained.

In the second embodiment, steps S220 and S230 in FIG. 7 may be omitted, so that after step S210 in FIG. 7, step S240 and the subsequent processes are executed. That is, a series of processes for the case in which the inter-vehicle distance D is greater than or equal to the first determination value D1 may be omitted. In this case also, the advantages except for the advantage (4) are obtained.

In the above illustrated embodiment, the accelerator operation is executed through depression of the accelerator pedal 8. However, the accelerator operation may be executed through operation other than pedal depression. Accelerator operating members other than the accelerator pedal 8 include a member operated by a hand such as a lever-type operating member provided in the vicinity of the steering wheel or the instrument panel. Likewise, the brake operation is executed through depression of the brake pedal 13 in the above illustrated embodiment. However, the brake operation may be executed through operation other than pedal depression. Brake operating members other than the brake pedal 13 include a member operated by a hand such as a lever-type operating member provided in the vicinity of the steering wheel or the instrument panel.

### DESCRIPTION OF THE REFERENCE NUMERALS

1 . . . Engine, 2 . . . Power Split Device, 3 . . . Drive Shaft, 4 . . . First Motor-Generator, 5 . . . Second Motor-Generator, 6 . . . Battery, 7 . . . Inverter, 8 . . . Accelerator Pedal, 9 . . . Accelerator Position Sensor, 10 . . . Vehicle Speed Sensor, 11 . . . Wheels, 12 . . . Brake Device, 13 . . . Brake Pedal, 14 . . . Brake Sensor, 15 . . . Electronic Control Unit, 20 . . . Intake Passage, 21 . . . Throttle Valve, 30 . . . Measuring Section

1. A vehicle control device comprising a controller, wherein
the controller executes a driving power limiting process, in which the controller reduces a driving power output by a drive source when an accelerator operating member and a brake operating member are being operated together in comparison to when only the accelerator operating member is operated, and
the controller is configured to execute a varying process in which the lower a vehicle speed is at a time when the accelerator operating member and the brake operating member are simultaneously operated, the shorter a period from when the accelerator operating member and the brake operating member are simultaneously operated to when the driving power limiting process is started becomes.

2. The vehicle control device according to claim 1, wherein
the controller is configured to start the driving power limiting process after a predetermined delay time has elapsed from when simultaneous operation of the accelerator operating member and the brake operating member is performed, and
the controller is configured to execute, as the varying process, a process in which the lower the vehicle speed is, the shorter the delay time is set to be.

3. The vehicle control device according to claim 1, wherein
the controller is configured to execute a gradual change process for gradually reducing the driving power in a period from when the accelerator operating member and the brake operating member are simultaneously operated to when the driving power limiting process is started, and
the controller is configured to execute, as the varying process, a process in which the lower the vehicle speed is, the greater a reduction amount by which the driving power is lowered per unit time during execution of the gradual change process becomes.

4. The vehicle control device according to claim 1, further comprising a measuring section adapted for measuring an inter-vehicle distance,
wherein the controller is configured such that, when the inter-vehicle distance is greater than or equal to a predetermined value, the controller prohibits execution of the varying process and sets a period from when the accelerator operating member and the brake operating member are simultaneously operated to when the driving power limiting process is started to a time longer than or equal to a longest time that is obtained when the varying process is executed.

5. The vehicle control device according to claim 1, further comprising a measuring section adapted for measuring an inter-vehicle distance,
wherein the controller is configured such that, when the inter-vehicle distance is less than or equal to a predetermined value, the controller prohibits execution of the varying process and sets a period from when the accelerator operating member and the brake operating member are simultaneously operated to when the driving power limiting process is started to a time shorter than or equal to a shortest time that is obtained when the varying process is executed.
